(19) United States
(12) Patent Application Publication
(10) Pub. No.: US 2026/0150128 A1
(43) Pub. Date: May 28, 2026

(54) TERMINAL AND COMMUNICATION METHOD

(71) Applicant: NTT DOCOMO, INC., Tokyo (JP)

(72) Inventors: Naoya Shibaike, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 19/122,889

(22) PCT Filed: Nov. 4, 2022
(86) PCT No.: PCT/JP2022/041264

§ 371 Date: Apr. 21, 2025

(51) Int. Cl. H04W 74/0808

(52) U.S. Cl. CPC H04W 74/0808

(57) ABSTRACT

A terminal includes: a control unit configured to determine whether or not to employ short control signaling (SCS) transmission in an unlicensed band; a transmitting unit configured to carry out transmission without performing listen before talk (LBT) when the control unit determines to employ SCS transmission; and a receiving unit configured to perform LBT when the control unit determines not to employ SCS transmission. The transmitting unit is configured to carry out transmission, when the control unit determines not to employ SCS transmission and the receiving unit ends LBT successfully.

### FIELD OF THE INVENTION

The present invention relates to a terminal and a communication method in a wireless communication system.

### BACKGROUND OF THE INVENTION

The requirements of “New Radio” (NR) (also referred to as “5G”), which is a successor system of long-term evolution (LTE), include large system capacity, high data transmission speed, low latency, simultaneous access from multiple terminals, low cost, power saving, and So forth, and a variety of technologies are under study to meet these requirements (see, for example, non-patent document 1).

3GPP (registered trademark) Release 17 has reached a consensus to support frequency bands beyond 52.6 GHz, up to 71 GHz (a band of this range will be hereinafter referred to as an “FR2-2”) and support carrier aggregation (CA) between an FR1 (410 MHz to 7.125 GHz) and FR2-2 (e.g., see non-patent document 2).

### RELATED-ART DOCUMENTS

### Non-Patent Documents

Non-Patent Document 1:3GPP TS 38.300 V 17.2.0 (2022-09)

Non-Patent Document 2:“Revised WID: Extending current NR operation to 71 GHz”, RP-212637, 3GPP TSG RAN Meeting #93-e, 3GPP, September, 2021

Non-Patent Document 3: 3GPP TS 38.212 V 17.3.0 (2022-09)

Non-Patent Document 4: 3GPP TS 37.213 V 17.3.0 (2022-09)

Non-Patent Document 5: 3GPP TS 38.331 V 17.2.0 (2022-09)

### SUMMARY OF THE INVENTION

### Technical Problem

In newly operated frequency bands in which higher frequencies are used than heretofore, both channel access with “listen before talk” (LBT) and channel access without LBT are supported. For example, it is necessary to choose the channel access mechanism so as to comply with laws and regulations in every country. Until now, it was not clear how to carry out transmissions based on short control signaling (SCS) without performing LBT.

The present invention has been made in view of the foregoing, and therefore aims to carry out SCS transmissions in a wireless communication system in which sensing is performed.

### Solution to Problem

According to the present disclosure, a terminal is provided. The terminal includes: a control unit configured to determine whether or not to employ short control signaling (SCS) transmission in an unlicensed band; a transmitting unit configured to carry out transmission without performing listen before talk (LBT) when the control unit determines to employ SCS transmission; and a receiving unit configured to

Perform LBT when the control unit determines not to employ SCS transmission. The transmitting unit is configured to carry out transmission, when the control unit determines not to employ SCS transmission and the receiving unit ends LBT successfully.

### Advantageous Effects of Invention

According to the present disclosure, it is possible to carry out SCS transmissions in a wireless communication system in which sensing is performed.

### BRIEF DESCRIPTION OF THE DRAWINGS

FIG. 1 is a diagram showing an example structure (1) of a wireless communication system;

FIG. 2 is a diagram showing an example structure (2) of a wireless communication system;

FIG. 3 is a diagram showing examples of frequency bands used in a wireless communication system;

FIG. 4 is a diagram for explaining an example (1) of LBT;

FIG. 5 is a diagram for explaining an example (2) of LBT;

FIG. 6 is a diagram for explaining an example (3) of LBT;

FIG. 7 is a diagram showing an example (1) of PRACH transmission according to an embodiment of the present invention;

FIG. 8 is a diagram showing an example (2) of PRACH transmission according to an embodiment of the present invention;

FIG. 9 is a diagram showing an example of capability reporting according to an embodiment of the present invention;

FIG. 10 is a diagram showing an example functional structure of a base station 10 according to an embodiment of the present invention;

FIG. 11 is a diagram showing an example functional structure of a terminal 20 according to an embodiment of the present invention;

FIG. 12 is a diagram showing an example hardware structure of a base station 10 or a terminal 20 according to an embodiment of the present invention; and

FIG. 13 is a diagram showing an example structure of a vehicle 2001 according to an embodiment of the present invention.

### DETAILED DESCRIPTION OF THE PREFERRED EMBODIMENTS

Now, an embodiment of the present invention will be described below with reference to the accompanying drawings. Note that the embodiment described below is only an example, and the applicability of the present invention is by no means limited to the following embodiment.

Existing techniques may be used as appropriate to operate the wireless communication system according to the following embodiment of the present invention. Examples H these existing techniques include, but are not limited to, existing LTE. Also, unless otherwise specified, the term “LTE” as used herein has a broad meaning, covering LTE-Advanced and systems that emerged after LTE-Advanced (for example, NR).

Also, in the following description of an embodiment of the present invention, terms that are used in existing LTE will be used, including “synchronization signal (SS)”, “primary SS (PSS)”, “secondary SS (SSS)”, “physical broadcast channel (PBCH)”, “physical random access channel (PRACH)”, “physical downlink control channel (PDCCH)”, “physical downlink shared channel (PDSCH)”, “physical uplink control channel (PUCCH)”, “physical uplink shared channel (PUSCH) ”, and so forth. This is for ease of description, and signals, functions, and so forth that are the same or substantially the same as these may be referred to by other names. Also, in NR, the above terms correspond to NR-SS, NR-PSS, NR-SSS, NR-PBCH, NR-PRACH, and so forth. Signals used in NR may not be always written with the prefix “NR-”.

Also, in the following embodiment of the present invention, the duplex method may be time division duplex (TDD), frequency division duplex (FDD), or any other method (including, for example, flexible duplex).

Also, in the following embodiment of the present invention, when a radio parameter or the like is “configured”, this may mean that a predetermined value is configured in advance (or “pre-configured”), or mean that a radio parameter or the like that is reported from a base station or a terminal is configured.

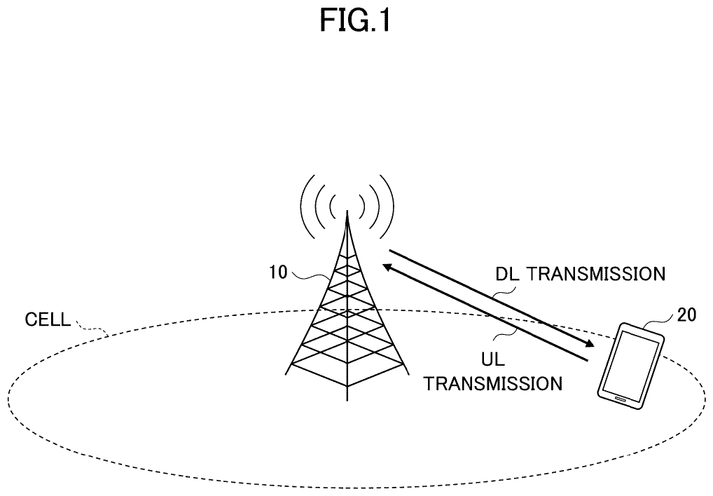

FIG. 1 is a diagram showing an example structure (1) of a wireless communication system according to an embodiment of the present invention. As shown in FIG. 1, according to an embodiment of the present invention, a wireless communication system includes a base station 10 and a terminal 20. Although one base station 10 and one terminal 20 are shown in FIG. 1, this is just one example, and there may be two or more of each.

The base station 10 is a communication device that provides one or more cells and performs wireless communication with the terminal 20. Physical resources for radio signals are given in the time domain and the frequency domain. The time domain resources may be indicated by the number of orthogonal frequency division multiplexing (OFDM) symbols, and the frequency domain resources may be indicated by the number of subcarriers or resource blocks. The base station 10 transmits synchronization signals and system information to the terminal 20. The synchronization 1.5 signals include, for example, NR-PSS and NR-SSS. The system information is transmitted, for example, on NR-PBCH, and is also referred to as “broadcast information”. The synchronization signals and system information may be referred to as “SS/PBCH block” (SSB). Referring to FIG. 1, the base station 10 transmits controls signal or data to the terminal 20 via downlink (DL), and receives control signals or data from the terminal 20 via uplink (UL). Both the base station 10 and the terminal 20 can transmit and receive signals by using beamforming. Also, both the base station 10 and the terminal 20 can apply multiple-input multiple-output (MIMO) communication to DL or UL. Also, the base station 10 and the terminal 20 may both communicate via a secondary cell (SCell) and a primary cell (PCell) in carrier aggregation (CA). Furthermore, in the event dual connectivity (DC) is deployed, the terminal 20 may communicate via a primary cell of the base station 10 and a primary secondary cell group cell (PSCell: Primary CGg Cell) of another base station 10.

The terminal 20 is a communication device with a wireless communication function, such as a smartphone, a mobile phone, a tablet, a wearable terminal, or a machine-to-machine (M2M) communication module. As shown in FIG. 1, the terminal 20 receives control signals or data from the base station 10 via DL, and transmits control signals or data to the base station 10 via UL, thereby using various communication services provided by the wireless communication system. Also, the terminal 20 receives various reference signals transmitted from the base station 10 and measures the quality of propagation paths based on the result of receiving these reference signals.

The terminal 20 is able to communicate with the base station 10 in carrier aggregation, in which multiple cells (component carriers (CCs) ) are bundled. In carrier aggregation, one primary cell (PCell) and one or more secondary cells (SCells) are used. A PUCCH-SCell having PUCCH may also be used.

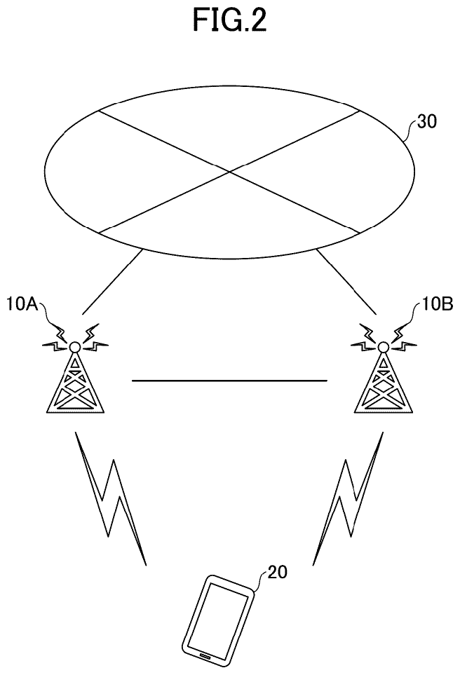

FIG. 2 is a second diagram for explaining a wireless communication system according to an embodiment of the present invention. FIG. 2 shows an example structure of a wireless communication system in which dual connectivity (DC) is employed. As shown in FIG. 2, there are a base station 10A that serves as a master node (MN) and a base station 10B that serves as a secondary node (SN). The base station 10A and the base station 10B are both connected to a core network 30. The terminal 20 can communicate with both the base station 10A and the base station 10B.

The cell group provided by the base station 10A, which is the MN, will be referred to as a “master cell group” (MCG). The cell group provided by the base station 10B, which is an SN, will be referred to as a “secondary cell group” (SCG). Also, in DC, the MCG consists of one PCell and one or more SCells, and an SCG consists of one primary SCG cell (PSCell) and one or more SCells.

The processes and operations according to this embodiment may be executed based on the system structure shown in FIG. 1, the system structure shown in FIG. 2, or any other system structure.

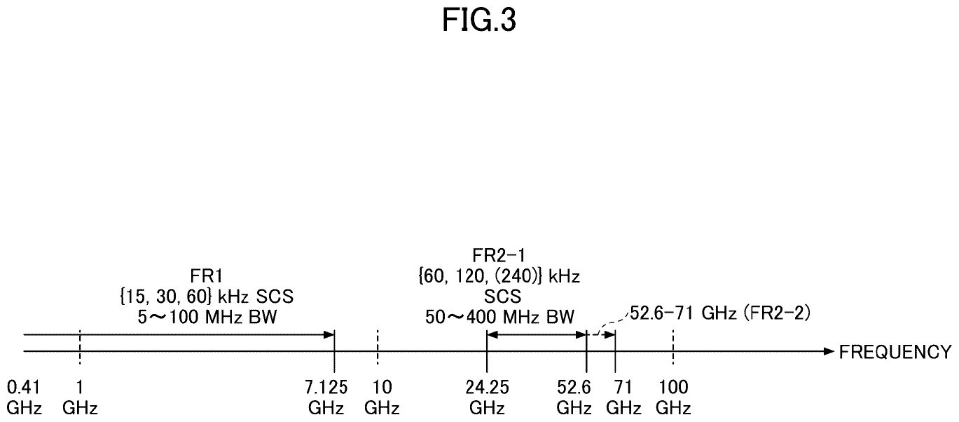

FIG. 3 shows examples of frequency bands used in a wireless communication system. According to the NR specifications of 3GPP Release 15 and Release 16, studies are underway to operate frequency bands of 52.6 GHz or higher. Note that, as shown in FIG. 3, the frequency range (FR) 1 that is currently under study for operation refers to a frequency band ranging from 410 MHz to 7.125 GHz, inclusive, where the subcarrier spacing (SCS) is 15, 30, or 60 KHz, and the bandwidth ranges from 5 MHz to 100 MHz.

FR2-1 refers to a frequency band from 24.25 GHz to 52.6 GHz, where the SCS is 60, 120, or 240 kHz, and the bandwidth ranges from 50 MHz to 400 MHz. As shown in FIG. 3, FR2-2 may be assumed to range from 52.6 GHz to 71 GHz. Furthermore, it may be assumed that frequency bands beyond 71 GHz are also supported.

When, for example, a band beyond 52.6 GHz is used, cyclic prefix-orthogonal frequency division multiplexing (CP-OFDM)/discrete Fourier transform-spread orthogonal frequency division multiplexing (DFT-S-OFDM) with larger subcarrier spacing (SCS) may be employed.

Also, in high frequency bands such as FR2-2, increased phase noise between carriers can be a problem.

In such a case, larger (wider) SCS or a single-carrier waveform may have to be employed.

Examples of unlicensed bands in the 5 GHz to 7 GHz band include one from 5.15 GHz to 5.35 GHz, one from 5.47 GHz to 5.725 GHz, one of 5.925 GHz and beyond, etc.

Examples of unlicensed bands in the 60 GHz band include one from 59 GHz to 66 GHz, one from 57 GHz to 64 GHz or 66 GHz, one from 59.4 GHz to 62.9 GHz, etc.

Various regulations are stipulated regarding unlicensed bands to prevent them from affecting other systems or other devices.

For example, in the 5 GHz to 7 GHz band, “listen before talk” (LBT) is performed when accessing a channel. The base station 10 or the terminal 20 detects power in a predetermined period immediately before carrying out a transmission. If power that is greater than a certain value is detected, that is, if a transmission from another device is detected, the base station 10 or the terminal 20 stops the transmission (which may be referred to as an “LBT failure”). Also, the maximum channel occupancy time (MCOT) is specified. MCOT is the maximum period of time a transmission is allowed to continue once it is started after LBT. For example, the MCOT in Japan is 4 ms.

Also, the occupied channel bandwidth (OCB) requirement states that, if a transmission is going to be carried out using a certain carrier bandwidth, at least X % of that band must be used. For example, in Europe, it is required to use 80% to 100% of the nominal channel bandwidth (NCB). The OCB requirement is intended to ensure that power is detected accurately when accessing a channel.

Regarding the maximum transmission power and maximum power spectral density, it is specified that a transmission be carried out using predetermined transmission power or less so as to avoid producing severe interference. For example, in Europe, the maximum transmission power is 23 dBm in the 5,150 MHz to 5,350 MHz band. Furthermore, in Europe, the maximum power spectral density is 10 dBm/MHz in the 5,150 MHz to 5,350 MHz band.

For example, in the 60 GHz band, LBT is performed when accessing a channel. The base station 10 or the terminal 20 detects power in a predetermined period immediately before carrying out a transmission, and, if power that is greater than a certain value is detected, that is, if a transmission from another device is detected, the base station 10 or the terminal 20 stops the transmission. In addition, with regard to the maximum transmission power and maximum power spectral density, it is specified that a transmission be carried out using predetermined transmission power or less. In addition, it is specified that the base station 10 or the terminal 20 has capabilities to satisfy the OCB requirement.

NR defines the following four types of channel access procedures based on differences in LBT's behavior over time (sensing period). Note that this “sensing” refers to a different operation from the sidelink sensing mentioned earlier, and will be hereinafter referred to as “LBT sensing” for distinction.

Type 1: Time-varying LBT sensing is performed before a transmission is carried out. This is also referred to as “category 4 LBT”.

Type 2A: 25 μs-long LBT sensing is performed before a transmission is carried out. This is also referred to as “category 2 LBT”.

Type 2B: 16 μs-long LBT sensing is performed before a transmission is carried out. This is also referred to as “category 2 LBT”.

Type 2C: A transmission is started without LBT, which is the same or substantially the same as how transmissions are carried out in licensed bands.

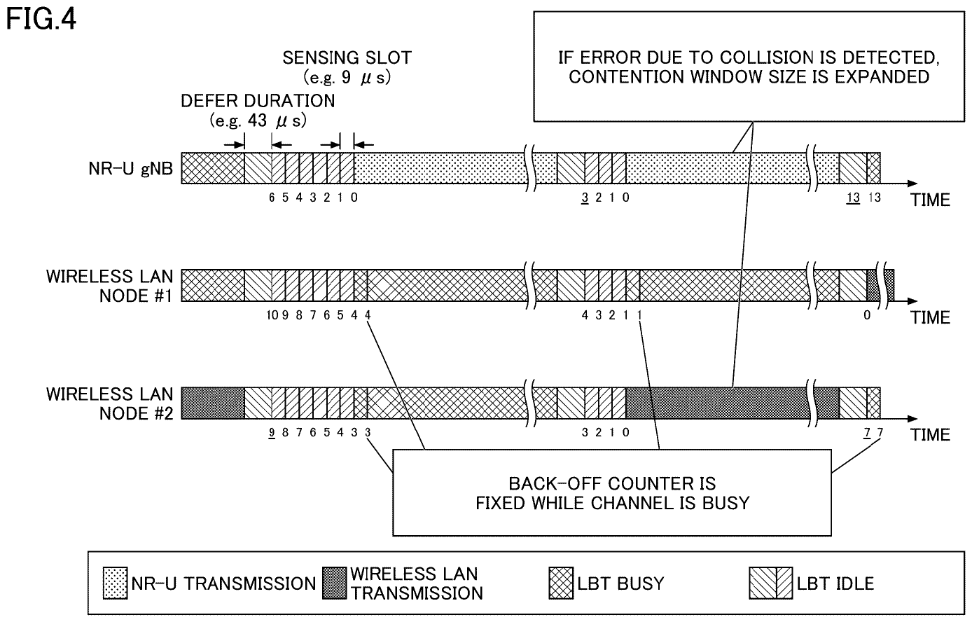

FIG. 4 is a diagram for explaining an example (1) of LBT. FIG. 4 is an example of type 1 channel access procedures. Type 1 is further classified into four “classes”, namely channel access priority classes (CAPCs), depending on the duration of LBT sensing. LBT sensing is performed in the following two periods.

The first period is a prioritization period or a defer duration, and has a length of 16+9×mₚ [μs] . A fixed value for mₚ is specified for each channel access priority class.

The second period is a backoff step and has a length of 9×N [μs]. The value of N is randomly determined from a certain range (see the CWS adjustment process in non-patent document 4). N is the initial value on a backoff counter; the backoff counter value is decreased by 1 every time 9 [μs] passes without detecting signaling power from other devices.

This 9 μs-long LBT sensing period may be referred to as an “LBT sensing slot period”.

In the example of FIG. 4, mₚ is 3 and the defer duration is 43 μs. As shown in FIG. 4, the backoff counter is fixed while the channel is busy. Also, referring to FIG. 4, in the event a transmissions from an NR-U gNB and a transmission from a wireless LAN node #2 collide and an error is detected, the contention window size (CWS) is expanded from 3 to 13 in the NR-U qNB.

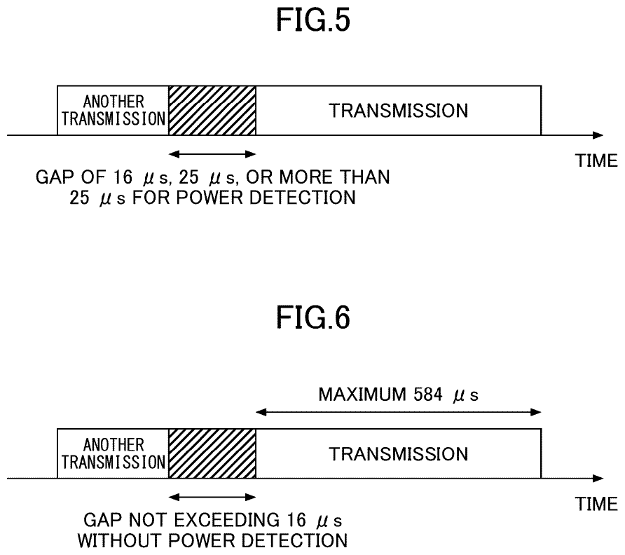

FIG. 5 is a diagram for explaining an example (2) of LBT. FIG. 5 is an example of type 2A or type 2B channel access procedures without random backoff. For pre-transmission power detection, a gap that is 25-μs long or longer is set in type 2A and a 16-μs long gap is set in type 2B.

FIG. 6 is a diagram for explaining an example (3) of LBT. FIG. 6 is an example of type 2C channel access procedures. In the example of FIG. 6, the transmission is not preceded by power detection and is carried out immediately after a gap not greater than 16 μs is over. The transmission period may be 584-μs long at most.

As mentioned earlier, NR-U supports multiple types of LBT. In above type 1, a random number is selected for the initial value N of the backoff counter, from a period that ranges from 0 to CWₚ. The value range is determined based on the channel access priority class p. Table 1 shows examples of mₚ, CWₚ's minimum value CW_{p, min}, and CWₚ's maximum value CW_{p, max}, specified per channel access priority class p in UL.

TABLE 1

| Class p | mₚ | CW_{min, p} | CW_{max, p} |
|---|---|---|---|
| 1 | 2 | 3 | 7 |
| 2 | 2 | 7 | 15 |
| 3 | 3 | 15 | 1023 |
| 4 | 7 | 15 | 1023 |

As shown in Table 1, mₚ, CW_{p, min}, and CW_{p, max} are determined by the channel access priority class p. When p is 1, the LBT period calculated from Table 1 is minimum 34 μs and maximum 88 μs. When p is 2, the LBT period calculated from Table 1 is minimum 34 μs and maximum 160 us. When p is 3, the LBT period calculated from Table 1 is minimum 43 μs and maximum 9,286 μs. When p is 4, the LBT period calculated from Table 1 is minimum 79 μs and maximum 9,286 μs. Note that Table 1 is to be used for UL.

The type of LBT and the channel access priority class may be determined based on notification from the base station 10, the channel type, etc. The 25 μs or 16 μs gap may be set by scheduling by the base station 10, taking into account timing advance (TA) and CP extension.

LBT is performed when accessing a channel access and performed for every predetermined bandwidth (e.g., 20 MHz). This predetermined bandwidth may be referred to as an “LBT channel”, an “RB set”, or an “LBT band”, but these are only examples. Every time a transmission is going to be carried out, if no power is detected in the LBT channel in which the transmission is included, the transmission can be carried out. On the other hand, every CC in Uu may be defined with a bandwidth wider than the LBT channel. In other words, wideband operation is supported. Note that “Uu” refers to a wireless interface between a universal terrestrial radio access network (UTRAN) and user equipment (UE).

Regulations regarding frequency bands such as those described above include, for example, a regulation by the European conference of postal and telecommunications administrations (CEPT) and broadband radio access networks (BRAN) that requires that LBT be performed on a mandatory basis. On the other hand, there are regulations that require not to perform LBT. Which regulation applies depends on, for example, the mobility of the terminal 20, that is, whether the terminal 20 is a fixed terminal or a mobile terminal.

Also, CEPT/RAN regulations support short control signaling transmission (SCS transmission). The details will be described later.

Furthermore, for example, according to the federal communications commission (FCC), there is no requirement to reduce interference in the 57 GHz to 71 GHz band. On the other hand, according to Japan's laws and regulations, carrier sensing is a must before a transmission is started using transmission power greater than 10 mW. Note that carrier sensing has a similar mechanism to LBT, but the details have not been determined yet.

Also, under 3GPP, studies are underway to support both channel access with LBT and channel access without LBT when a base station 10 or a terminal 20 starts occupying a channel. Also, regarding LBT's mechanism, an omni-directional LBT type, a directional LBT type, a receiver-initiated LBT type, and other mechanisms are being studied.

Also, whether or not it is necessary to place restrictions on the operation of channel access without LBT is being discussed. For example, assuming that automatic transmit power control (ATPC), dynamic frequency selection (DFS), long-term sensing, and/or other interference reduction mechanisms are employed in order to satisfy the laws and regulations, whether or not it is necessary to restrict the operation of channel access without LBT has to be considered.

Furthermore, the mechanism or the conditions for switching between channel access with LBT and channel access without LBT (with an assumption that the local laws and regulations permit this, for example) are under study.

For example, for the 60 GHz band, providing support for two media access mechanisms, namely channel access with LBT and channel access without LBT, is under study.

For example, providing support for three types of channel access is under study: namely, channel access without LBT, channel access with long-term sensing, and channel access with short-term sensing. For example, channel access without LBT may be used when conditions regarding equivalent isotopically radiated power (EIRP), transmission power, channel occupancy duty cycle, and space multiplexing-related characteristics are satisfied. Also, channel access with long-term sensing is an approach that enables re-use of beams when a large number of beams collide. Channel access with short-term sensing is a type of LBT.

As for the types of LBT, there are the following (1) to (3):
(1) LBT in which the sensing period is determined randomly. Type 1 LBT according to Release 16 NR-U (NR system using unlicensed bands) is an example. Although the possibility is low that transmissions from multiple devices collide with each other, backoff-induced delays of transmission timings might occur.
(2) LBT in which the sensing period is fixed. Type 2a/2b LBT according to Release 16 NR-U is an example. Although the possibility is high that transmissions from multiple devices collide with each other, there is no backoff, so that the delays in transmission timings are not significant.
(3) Transmission is carried out immediately, without sensing. Type 2c LBT according to Release 16 NR-U is an example.

Short control signaling (exempt) transmission will be also referred to as “SCSe transmission” hereinafter. SCSe transmission refers to a specific mode of transmission that does not require LBT and that is carried out without channel sensing. In CEPT/BRAN, SCSe transmission is defined as follows.

SCSe transmission refers to a type of transmission that a device employs when sending management and control frames without conducting channel sensing to detect the presence of other signals. The total duration of SCSe transmission is limited to less than 10 ms in the 100 ms-long observation period.

As mentioned earlier, SCSe transmission is supported by laws and regulations in Europe.

Also, UL-SCSe transmission is under study by 3GPP. For example, a PRACH may be transmitted using SCSe transmission. Therefore, in Europe, LBT may not be needed for PRACH transmission.

However, it is not clear how to determine whether or not a UE is located in Europe. In other words, it is not clear how to determine whether or not a PRACH is transmitted using SCSe transmission.

For example, the method of notifying a UE whether it is located in Europe by using SIB1 or an RRC parameter has never been adopted. Unless whether a UE is located in Europe can be determined, it is difficult to transmit a PRACH using SCSe transmission in any area.

There is a method of identifying the area where a UE is located based on a public land mobile network (PLMN) ID contained in SIB1. The PLMN-ID includes a mobile country code (MCC) and a mobile network code (MNC). The MCC is three digits. For example, “2xx” indicates Europe, “440” or “441” indicates Japan, and “999” indicates a non-public network (NPN) in any country. The MNC is two digits.

Therefore, when identifying a UE's location using the PLMN-ID, in the event a mobile network operator (MNO) is used, it is possible to identify the area. For example, if the MCC is 440 or 441, Japan is identified, and, if the MCC is 2xx, Europe is identified. However, in the event a non-MNO operator such as local 5G is used, it is not possible to identify the area. In other words, the method of identifying the area using the PLMN-ID is not a perfect solution. It is therefore difficult to transmit a PRACH using SCSe transmission.

SCSe transmission may be applicable only in specific geographic regions or countries. SCSe transmission may be referred to as (1) or (2) below.
(1) PRACH transmission without LBT
(2) Sensing-exempted transmission

The specific geographic regions or countries may be any of following (1) to (3).
(1) Outside Japan
(2) Europe
(3) Areas where ETSI/BRAN regulations apply

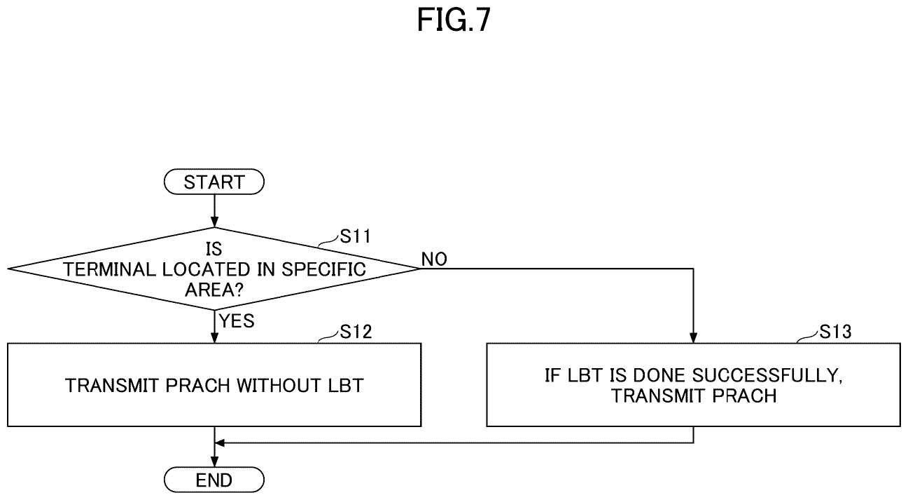

FIG. 7 is a flowchart showing an example (1) of PRACH transmission according to an embodiment of the present invention. In step S11, the terminal 20 decides whether the terminal 20 is located in a specific geographic region. If the terminal 20 is located in a specific geographic region (“YES”in S11), the process proceeds to step S12. If the terminal 20 is not located in a specific geographic region (“NO”in S11), the process proceeds to step S13. In step S12, the terminal 20 transmits a PRACH without performing LBT. In step S13, if the terminal performs and ends LBT successfully, the terminal 20 transmits a PRACH.

Note that changes may be made such that the SCSe rule is applied to step S12 and not applied to step S13.

Note that the decision in step S11 may be made based on the MCC included in SIB1. Also, if the terminal 20 is connected to a non-MNO network, the decision in step S11 may be made based on other methods. For example, the area in which the terminal 20 is located may be determined based on geographical information from a global navigation satellite system (GNSS).

The above-described operation makes it possible to satisfy the laws and regulations of each country and maximize SCSe's use cases. Also, PRACH transmission without LBT becomes possible in areas outside Japan.

Providing a DCI field that specifies the type of LBT to be applied to PRACH transmission may be supported. A DCI field that specifies the type of LBT to be applied to PRACH transmission may be provided in one or more of the DCIs of (1) to (4) below.

(1) DCI that triggers random access by a PDCCH command. For example, the CRC part may be scrambled with C-RNTI, and a DCI format 1_0 with a frequency domain resource assignment (FDRA) field entirely composed of 1's may be used.

(2) DCI for scheduling DL transmission. For example, a DCI format 1_x may be used.

(3) DCI for scheduling UL transmission. For example, a DCI format 0_x may be used.

(4) Group-common DCI. For example, a DCI format 2_x may be used.

The number of bits to constitute the DCI field that specifies the type of LBT to be applied to PRACH transmission may be one of (1) and (2) below.

(1) 1 bit.

For example, may indicate that PRACH transmission requires LBT, and “1” may indicate that PRACH transmission does not require LBT. Note that the type of LBT to be used when the pertinent DCI field is 1 bit may be determined based on UE implementation.

(2) 2 bits.

For example, the entry indices shown in Table 2 below may be defined (see non-patent documents 3 and 4).

TABLE 2

| ENTRY | |
|---|---|
| INDEX | CHANNEL ACCESS TYPE |
| 0 | TYPE 1 CHANNEL ACCESS TYPE DEFINED IN |
| | 37.213 § 4.4.1 |
| 1 | TYPE 2 CHANNEL ACCESS TYPE DEFINED IN |
| | 37.213 § 4.4.1 |
| 2 | TYPE 3 CHANNEL ACCESS TYPE DEFINED IN |
| | 37.213 § 4.4.1 |

The DCI field that specifies the type of LBT to be applied to PRACH transmission may be present when at least one of the following conditions (1) to (4) is satisfied.
(1) The operation is taking place in FR2-2.
(2) Shared spectrum channel access is employed.
(3) The DCI field may be always present.
(4) The RRC parameter “channelAccessMode2” is configured and/or enabled (see non-patent document 5).

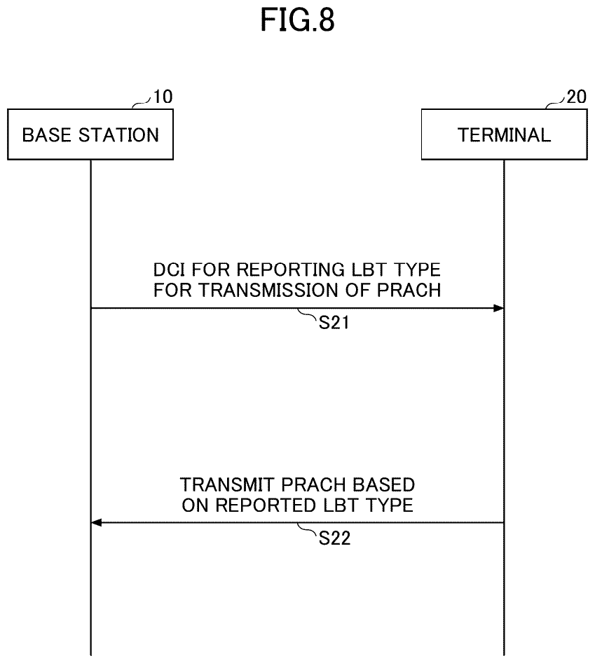

FIG. 8 is a sequence diagram showing an example (2) of PRACH transmission according to an embodiment of the present invention. In step S21, the base station 10 transmits DCI that reports the type of LBT for PRACH transmission to the terminal 10. In the following step S22, the terminal 20 transmits a PRACH to the base station 10 based on the type of LBT reported.

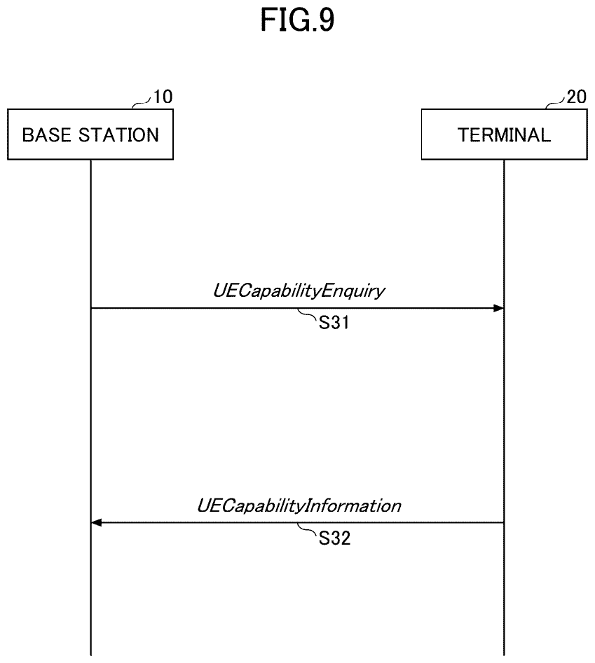

FIG. 9 is a sequence diagram showing capability reporting according to an embodiment of the present invention (see non-patent document 5) . In step S31, the base station 10 transmits “UECapabilityEnquiry” to the terminal 20. In the following step S32, the terminal 20 transmits “UECapabilityInformation” to the base station 10.

Signaling of UE capabilities such as (1) and (2) below may be supported.
(1) UE capability that indicates whether or not the UE supports PRACH transmission without LBT. This UE capability may indicate whether or not the UE understands the rule for employing SCSe transmission.
(2) UE capability that indicates whether or not the UE can interpret the DCI field that specifies the type of LBT to be applied to PRACH transmission.

Also, providing an RRC parameter for configuring whether or not to employ SCSe transmission may be supported.

Note that SCSe transmission is not limited to being applied to PRACH transmission, and may be used when other control signals or other channels are transmitted. Note that SCSe transmission and SCS transmission may be interchangeable. Also, PRACH may be referred to a “msg1” or “msgA”.

According to the above-described embodiment, the terminal 20 can appropriately determine whether or not to employ SCSe transmission when transmitting a PRACH.

In other words, short control signaling (SCS) transmission can be carried out in a wireless communication system in which sensing is performed.

### Device Structure

Next, example functional Structures of the base station 10 and the terminal 20 having functions to implement the above-described processes and operations will be described. The base station 10 and the terminal 20 have functions to carry out the above-described embodiment. However, both the base station 10 and the terminal 20 may have only some of the functions of the embodiment.

### Base Station 10

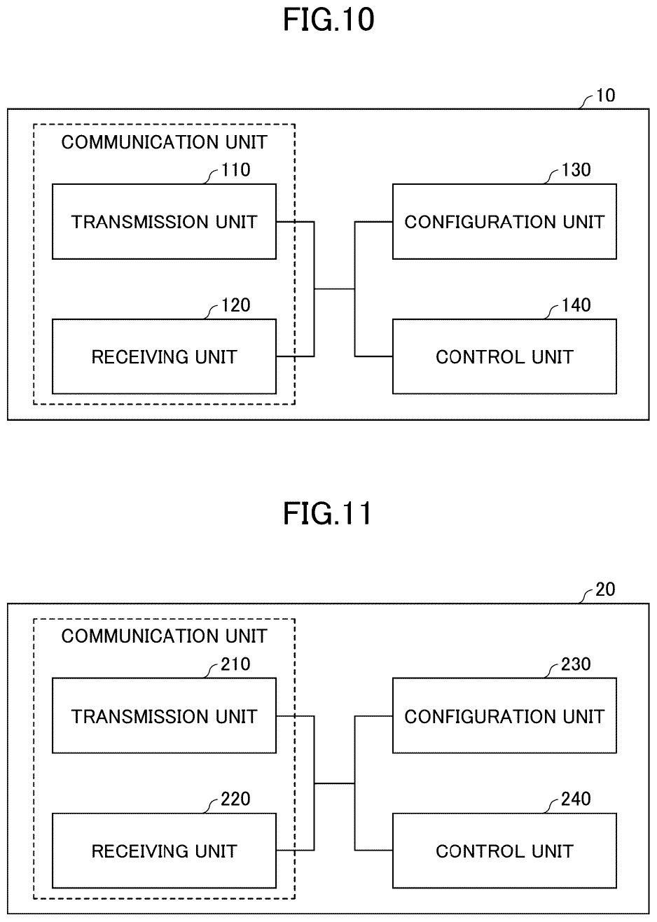

FIG. 10 is a diagram showing an example functional structure of a base station 10 according to an embodiment of the present invention. As shown in FIG. 10, the base station 10 has a transmitting unit 110, a receiving unit 120, a configuration unit 130, and a control unit 140. The functional structure shown in FIG. 10 is simply an example. As long as the operations according to the embodiment of the present invention can be implemented, any functional categories and any functional unit names may be used.

The transmitting unit 110 has, for example, a function to generate signals to be transmitted to the terminal 20 or other network nodes and transmit the signals via a wireless connection. The transmitting unit 110 also transmits inter-network node messages to other network nodes. The receiving unit 120 has, for example, a function to receive various signals transmitted from the terminal 20 and acquire, for example, higher layer information from the received signals. Also, the transmitting unit 110 has a function to transmit NR-PSS, NR-SSS, NR-PBCH, DL/UL control signals, etc., to the terminal 20. Also, the receiving unit 120 receives inter-network node messages from other network nodes.

The configuration unit 130 stores configuration information that is set in advance, as well as various configuration information to be transmitted to the terminal 20. The content of the configuration information include, for example, information related to LBT.

The control unit 140 executes control to implement the functions described hereinabove with the embodiment. Also, the control unit 140 executes control related to LBT, as has been described with the embodiment. The functional unit related to signal transmission in the control unit 140 may be included in the transmitting unit 110, and the functional unit related to signal reception in the control unit 140 may be included in the receiving unit 120.

### Terminal 20

FIG. 11 is a diagram showing an example functional structure of a terminal 20 according to an embodiment of the present invention. As shown in FIG. 11, the terminal 20 has a transmitting unit 210, a receiving unit 220, a configuration unit 230, and a control unit 240. The functional structure shown in FIG. 11 is simply an example. As long as the operations according to the embodiment of the present invention can be implemented, any functional categories and any functional unit names may be used.

The transmitting unit 210 creates transmission signals from transmission data and transmits them via a wireless connection. the receiving unit 220 receives various signals via a wireless connection, and obtains higher layer signals from the physical layer signals received. The receiving unit 220 also has a function to receive NR-PSS, NR-SSS, NR-PBCH, DL/UL/SL control signals, etc., transmitted from the base station 10. Furthermore, for example, in D2D communication, the transmitting unit 210 transmits a physical sidelink control channel (PSCCH), a physical sidelink shared channel (PSSCH), a physical sidelink discovery channel (PSDCH), a physical sidelink broadcast channel (PSBCH), etc., to other terminals 20, and the receiving unit 220 receives PSCCH, PSSCH, PSDCH, PSBCH, etc., from other terminals 20.

The configuration unit 230 stores various types of configuration information received from the base station 10 by the receiving unit 220. The configuration unit 230 also stores pre-configured configuration information. The content of the configuration information includes, for example, information related to LBT.

The control unit 240 executes control to implement the functions described hereinabove with the embodiment. Also, the control unit 240 executes control related to LBT as has been described with the embodiment. The functional unit related to signal transmission in the control unit 240 may be included in the transmitting unit 210, and the functional unit related to signal reception in the control unit 240 may be included in the receiving unit 220.

### Hardware Structure

The block diagrams (FIG. 10 and FIG. 11) used in the description of the above embodiment illustrate blocks of functional units. these functional blocks (components) are implemented by any combination of hardware and/or software. In addition, the method of implementing each functional block is not particularly limited. That is, each functional block may be implemented by using a single device that is physically or logically combined, or two or more devices that are physically or logically separated may be directly or indirectly connected (for example, by using a cable, radio, etc.), and each functional block may be implemented using these multiple devices. The functional blocks may be implemented by combining software with the device or devices.

The functions include, but are not limited to, judgment, determination, decision, calculation, computation, processing, derivation, research, search, verification, reception, transmission, output, access, resolution, selection, choosing, establishment, comparison, assumption, assumption, deeming, broadcasting, notifying, communicating, forwarding, configuring, reconfiguring, allocating, mapping, and assigning. For example, a functional block (component) that performs a transmission function is referred to as a “transmitting unit” or a “transmitter”. In either case, as described above, the method of implementation is not particularly limited.

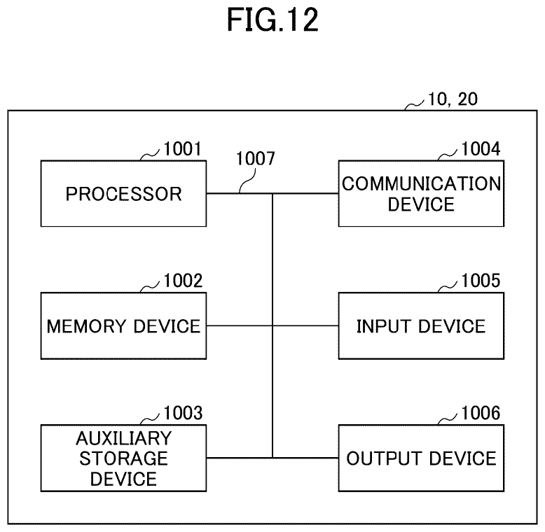

For example, the base station 10, the terminal 20, and so forth according to the embodiment of the present disclosure may function as a computer for processing the wireless communication method of the present disclosure. FIG. 12 is a diagram that illustrates an example hardware structure of the base station 10 and the terminal 20 according to the embodiment of the present disclosure. The network nodes may be structured the same or substantially the same as the base station 10. The USIM may be structured the same or substantially the same as the terminal 20. The base station 10 and the terminal 20 described above may be physically configured as a computer device including a processor 1001, a storage device 1002, an auxiliary storage device 1003, a communication device 1004, an input device 1005, an output device 1006, a bus 1007, and the like.

In the following description, the term “device” can be read as circuit, apparatus, unit, and so forth. The hardware structure of the base station 10 and the terminal 20 may be configured to include one or more of the devices illustrated in the drawings, or may be configured without some of the devices.

The functions of the base station 10 and the terminal 20 are realized by performing operations by the processor 1001 by reading predetermined software (programs) on hardware such as the processor 1001 and the storage device 1002, and controlling communication by the communication device 1004 and controlling at least one of reading and writing of data in the storage device 1002 and the auxiliary storage device 1003.

The processor 1001 operates, for example, an operating system to control the entire computer. The processor 1001 may be composed of a central processing unit (CPU) including an interface with peripheral devices, a control device, an arithmetic device, a register, and the like. For example, the above-described control unit 140, control unit 240, and the like may be implemented by the processor 1001.

The processor 1001 reads out programs (program codes), software modules, data, or the like from at least one of the auxiliary storage device 1003 and the communication device 1004 to the storage device 1002, and performs various processes in accordance with the above. As for the programs, programs that cause the computer to execute at least part of the operations described in the above embodiment may be used. For example, the control unit 140 of the base station 10 illustrated in FIG. 10 may be stored in the storage device 1002 and implemented by control programs that operate on the processor 1001. For example, the control unit 240 of the terminal 20 illustrated in FIG. 11 may be stored in the storage device 1002 and implemented by control programs that operate on the processor 1001. Although the foregoing processes have been described and executed by one processor 1001, they may be executed simultaneously or sequentially by two or more processors 1001. The processor 1001 may be implemented by one or more chips. The programs may be transmitted from the network via a telecommunication line.

The storage device 1002 is a computer-readable recording medium and may be composed of at least one of, for example, a read-only memory (ROM), an erasable programmable ROM (EPROM), an electrically erasable programmable ROM (EEPROM), a random access memory (RAM), and the like. The storage device 1002 may be referred to as a register, cache, main memory (main storage device), or the like. The storage device 1002 can store programs (program codes), software modules, and so forth, executable to implement the communication method according to the embodiment of the present disclosure.

The auxiliary storage device 1003 is a computer-readable recording medium and may be composed of at least one of an optical disk, such as a compact disc ROM (CD-ROM), a hard disk drive, a flexible disk, a magneto-optical disk (for example, a compact disc, a digital versatile disc, a Blu-ray disc (registered trademark), etc.), a smart card, a flash memory (for example, a card, a stick, a key drive), a floppy disk (registered trademark), a magnetic strip, and the like. The storage medium described above may be, for example, a database, a server, or other suitable medium that includes at least one of a storage device 1002 and an auxiliary storage device 1003.

The communication device 1004 is hardware (a transceiving device) for performing communication between computers via at least one of a wired network and a wireless network, and is also referred to as a “network device”, a “network controller”, a “network card”, a “communication module”, or the like. The communication device 1004 may be composed of a high frequency switch, a duplexer, a filter, a frequency synthesizer, or the like, for example, to implement at least one of frequency division duplex (FDD) and time division duplex (TDD). For example, the transmitting/receiving antenna, the amplifier unit, the transceiving unit, the transmission line interface, and the like may be implemented by the communication device 1004. The transceiving unit may be physically or logically isolated, respective implementations of a transmitting unit and a receiving unit.

The input device 1005 is an input device (for example, a keyboard, a mouse, a microphone, a switch, a button, a sensor, etc.) that accepts external input. The output device 1006 is an output device (for example, a display, a speaker, an LED lamp, etc.) that implements external output. The input device 1005 and the output device 1006 may have an integral structure (for example, a touch panel).

Each device, such as the processor 1001 and the storage device 1002, is connected by a bus 1007 for communicating information. The bus 1007 may be constructed using a single bus or may be constructed using different buses between devices.

The base station 10 and the terminal 20 may also include hardware such as a microprocessor, a digital signal processor (DSP), an application-specific integrated circuit (ASIC), a programmable logic device (PLD), a field programmable gate array (FPGA), and so forth, and some or all of the functional blocks may be implemented by the hardware. For example, the processor 1001 may be implemented by using at least one of these hardware components.

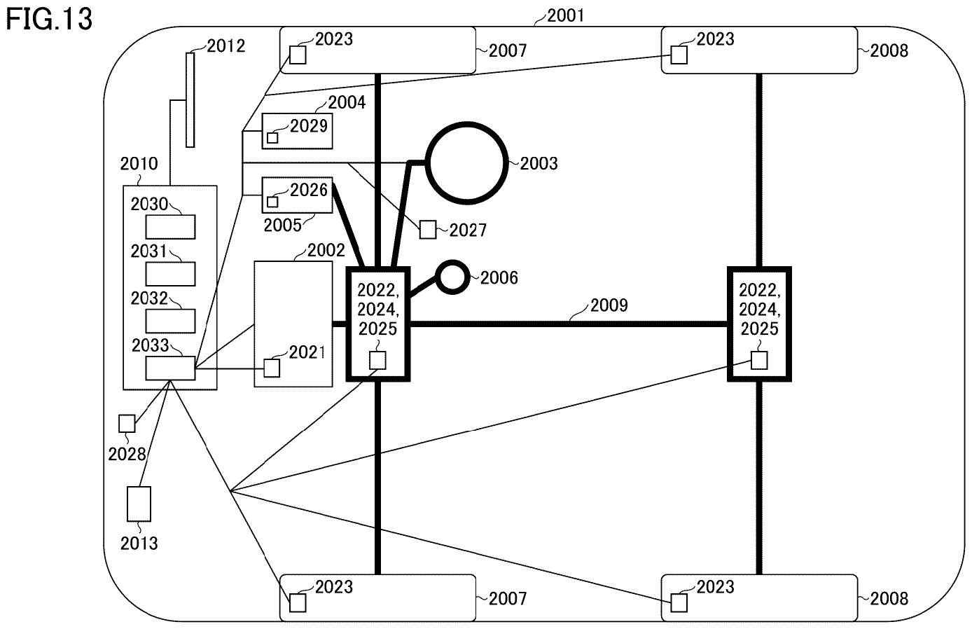

FIG. 13 shows an example structure of a vehicle 2001. As shown in FIG. 13, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013. The embodiment and examples described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a

steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (10 port) 2033. The electronic control unit 2010 receives signals from the sensors 2021 to 2029 provided in the vehicle 2001. The electronic control unit 2010 may be referred to as an “electronic control unit” (ECU).

The signals from the sensors 2021 to 2029 include a current signal from a current sensor 2021 that senses the current of the motor, a front or rear wheel rotation speed signal acquired by a rotation speed sensor 2022, a front or rear wheel air pressure signal acquired by an air pressure sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, a shift lever operation signal acquired by a shift lever sensor 2027, and a detection signal, acquired by an object detection sensor 2028, for detecting an obstacle, a vehicle, a pedestrian, and the like.

The information service unit 2012 includes various devices for providing various information such as driving information, traffic information, and entertainment information, including a car navigation system, an audio system, a speaker, a television, and a radio, and one or more ECUs that control these devices. The information service unit 2012 provides various multimedia information and multimedia services to the occupants of the vehicle 2001 by using information obtained from external devices through the communication module 2013 or the like. The information service unit 2012 may include an input device (for example, a keyboard, a mouse, a microphone, a switch, a button, a sensor, a touch panel, etc.) that accepts external inputs, and may also include an output device (for example, a display, a speaker, an LED lamp, a touch panel, etc.) that executes external outputs.

A driver assistance system unit 2030 includes: various devices for providing functions of preventing accidents and reducing the driver's burden of driving, such as a millimeter wave radar, a light detection and ranging (LiDAR) system, a camera, a positioning locator (for example, GNSS), map information (for example, high definition (HD) map, autonomous vehicle (AV) map, etc.), a gyro system (for example, an inertial measurement unit (IMU), an inertial navigation system (INS), etc.), an artificial intelligence (AI) chip, and an AI processor; and one or more ECUs that control these devices. In addition, the driver assistance system unit 2030 transmits and receives various information via the communication module 2013 to implement a driver assistance function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031, the memory (ROM, RAM) 2032 in the electronic control unit 2010, and the sensors 2021 to 29 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through wireless communication. The communication module 2013 may be internal or external to the electronic control unit 2010. The external devices may include, for example, a base station, a mobile station, or the like.

The communication module 2013 may transmit at least one of: signals input to the electronic control unit 2010 from the sensors 2021 to 2029; information obtained based on these signals; and information based on inputs from the outside (user) obtained via the information service unit 2012, to external devices via wireless communication. The electronic control unit 2010, the sensors 2021 to 2029, the information service unit 2012, and the like may be referred to as an “input unit” that accepts inputs. For example, PUSCH transmitted by the communication module 2013 may include information that is based on an input such as one described above.

The communication module 2013 receives various information (traffic information, signal information, inter-vehicle distance information, etc.) transmitted from external devices and displays these pieces of information on an information service unit 2012 provided in the vehicle 2001. The information service unit 2012 may also be referred to as an “output unit” that outputs information (or that, for example, outputs information to devices such as a display or a speaker based on PDSCH (or data/information decoded from PDSCH) received by the communication module 2013). In addition, the communication module 2013 stores the information received from the external devices in the memory 2032, to which the microprocessor 2031 has access. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2029, and so forth, mounted in the vehicle 2001.

### Summary of Embodiment

As described above, according to an embodiment of the present invention, a terminal is provided. This terminal includes: a control unit configured to determine whether or not to employ short control signaling (SCS) transmission in an unlicensed band; a transmitting unit configured to carry out transmission without performing listen before talk (LBT) when the control unit determines to employ SCS transmission; and a receiving unit configured to perform LBT when the control unit determines not to employ SCS transmission. The transmitting unit is configured to carry out transmission when the control unit determines not to employ SCS transmission and the receiving unit ends LBT successfully.

Structured thus, the terminal 20 can appropriately determine whether or not to employ SCSe transmission when transmitting a PRACH. In other words, the terminal 20 can carry out short control signaling (SCS) transmissions in a wireless communication system in which sensing is performed.

The above control unit may be configured to determine whether or not the terminal is located in a specific geographic region and determine to employ SCS transmission when the terminal is located in the specific geographic region. Structured thus, the terminal 20 can appropriately determine whether or not to employ SCSe transmission when transmitting a PRACH.

The above control unit may be configured to determine whether or not the terminal is located in a specific geographic region based on a mobile country code (MCC) included in system information. Structured thus, the terminal 20 can appropriately determine whether or not to employ SCSe transmission when transmitting a PRACH.

The above receiving unit may be configured to receive downlink control information from a base station. The above control unit may be configured to determine whether or not to employ SCS transmission based on the downlink control information. Structured thus, the terminal 20 can appropriately determine whether or not to employ SCSe transmission when transmitting a PRACH.

The transmitting unit may be configured to perform random access channel transmission without performing LBT when the control unit determines to employ SCS transmission. Structured thus, the terminal 20 can appropriately determine whether or not to employ SCSe transmission when transmitting a PRACH.

Furthermore, according to an embodiment of the present invention, a communication method is provided. This communication method includes: a step of determining whether or not to employ short control signaling (SCS) transmission in an unlicensed band; a step of carrying out transmission without performing listen before talk (LBT) upon determining to employ SCS transmission; a step of performing LBT upon determining not to employ SCS transmission; and a step of carrying out transmission upon determining not to employ SCS transmission and successfully ending LBT.

Structured thus, the terminal 20 can appropriately determine whether or not to employ SCSe transmission when transmitting a PRACH. In other words, the terminal 20 can carry out short control signaling (SCS) transmissions in a wireless communication system in which sensing is performed.

### Notes on Embodiment

An example embodiment of the present invention has been described above, but the disclosed invention is not limited to the above embodiment, and those skilled in the art would understand that there may be various modified examples, revised examples, alternative examples, substitution examples, and the like. In order to facilitate understanding of the invention, specific numerical values have been used for description, but the numerical values are merely examples, and any suitable values may be used unless otherwise specified. The classification of items in the above description is not essential to the present invention. Matters described as two or more items may be combined if necessary, and a matter described as one item may be applied to another item (as long as there is no contradiction). The boundary between functional units or processing units in a functional block diagram does not necessarily correspond to the boundary between physical parts. Operations of multiple functional units may be performed physically by one component, or an operation of one functional unit may be physically performed by multiple parts. In the processing procedures described in the embodiment, the order of the processes may be changed as long as there is no contradiction. For the sake of convenience of processing description, the base station 10 and the terminal 20 are described using functional block diagrams, but such devices may be implemented by hardware, software, or a combination of these. Software executed by the processor included in the base station 10 according to the embodiment of the present invention and software executed by the processor included in the terminal 20 according to the embodiment of the present invention may be stored in a random access memory (RAM), a flash memory, a read-only memory (ROM), an EPROM, an EEPROM, a register, an hard disk drive (HDD), a removable disk, a CD-ROM, a database, a server, or any other appropriate storage medium.

Furthermore, notification of information is not limited to the embodiment or examples described in the present disclosure, and may be provided by using any other method. For example, the notification of information may be provided by physical layer signaling (for example, downlink control information (DCI) or uplink control information (UCI)), higher layer signaling (for example, radio resource control (RRC) signaling, medium access control (MAC) signaling, broadcast information (master information block (MIB), system information block (SIB), etc.), other signals, or a combination thereof. Furthermore, RRC signaling may be referred to as an “RRC message” and may be, for example, an RRC connection setup message, an RRC connection reconfiguration message, or the like.

Each embodiment and example described in the present disclosure may be applied to at least one of long-term evolution (LTE), LTE-advanced (LTE-A), SUPER 3G, IMT-Advanced, 4th generation mobile communication system (4G), 5th generation mobile communication system (5G), 6th generation mobile communication system (6G), x-th generation mobile communication system (xG) (where “x” is an integer, decimal, etc.), future radio access (FRA), new radio (NR), new radio access (NX), future generation radio access, W-CDMA (registered trademark), GSM (registered trademark), CDMA 2000, ultra mobile broadband (UMB), IEEE 802.11 (Wi-Fi (registered trademark) ), IEEE 802.16 (WiMAX (registered trademark) ), IEEE 802.20, ultra-wideband (UWB), Bluetooth (registered trademark), a system using any other appropriate system, and next generation systems enhanced, modified, created, and defined based on these standards. Furthermore, multiple systems (for example, a combination of at least one of LTE and LTE-A, with 5G) may be combined to be applied.

The order of the processing procedures, the order of the sequences, the order of the flowcharts, and the like of the embodiment and examples described in this specification may be changed, provided that there is no contradiction. For example, the method described in the present disclosure presents elements of various steps with an example order and is not limited to the presented, specific order.

In this specification, a specific operation to be performed by the base station 10 may be performed by its upper node in some cases. In a network including one or more network nodes including the base station 10, various operations performed for communication with the terminal 20 can be obviously performed by at least one of the base station 10 and any network node (for example, an MME, an S-GW, and so forth, but these are by no means limiting) other than the base station 10. Cases have been shown above in which there is one network node other than the base station 10. The one network node may be a combination of multiple other network nodes (for example, MME and S-GW) .

Information, a signal, or the like described in the present disclosure may be output from a higher layer to a lower layer (or from a lower layer to a higher layer). Information, a signal, or the like described in the present disclosure may be input and output via multiple network nodes.

Input and output information and the like may be stored in a specific place (for example, a memory), or may be managed by using a management table. Input and output information and the like may be overwritten, updated, or additionally written. Output information and the like may be deleted. Input information and the like may be transmitted to other devices.

The determination in the present disclosure may be made in accordance with a value (0 or 1) represented by one bit, may be made in accordance with a Boolean value (Boolean: true or false), or may be made by a comparison of numerical values (for example, a comparison with a predetermined value).

Software should be broadly interpreted to mean a command, a command set, a code, a code segment, a program code, a program, a subprogram, a software module, an application, a software application, a software package, a routine, a subroutine, an object, an executable file, an execution thread, a procedure, a function, and the like, regardless of whether software is called “software”, “firmware”, “middleware”, a “microcode”, a “hardware description language”, or any other name.

Furthermore, software, commands, information, and the like may be transmitted and received via a transmission medium. For example, when software is transmitted from a web site, a server, or any other remote source using a wired technology (such as a coaxial cable, a fiber optic cable, a twisted pair, or a digital subscriber line (DSL)) and a radio technology (such as infrared rays or a microwave), at least one of these wired technology and radio technology is included in a definition of a transmission medium.

Information, signals, and the like described in the present disclosure may be expressed using any one of a variety of techniques. For example, data, instructions, commands, information, signals, bits, symbols, chips, and the like, which are mentioned throughout the above description, may be expressed by voltages, currents, electromagnetic waves, magnetic fields or magnetic particles, optical fields or photons, or any combination thereof.

The terms described in the present disclosure and the terms necessary for understanding the present disclosure may be replaced with terms having the same or similar meanings. For example, at least one of a channel and a symbol may be a signal (signaling). Furthermore, a signal may be a message. Furthermore, a component carrier (CC) may be referred to as a “carrier frequency”, a “cell”, a “frequency carrier”, or the like.

The terms “system” and “network” used in the present disclosure are interchangeable.

Furthermore, the information, parameters, and the like described in the present disclosure may be expressed by using absolute values, may be expressed by using relative values from predetermined values, or may be expressed by using any other corresponding information. For example, radio resources may be indicated by indices.

The names used for the above-described parameters are not limited names in any point of view. Furthermore, mathematical formulas or the like using the parameters may be different from those explicitly disclosed in the present disclosure. Since various channels (for example, PUCCH, PDCCH, etc.) and information elements can be identified by any suitable names, various names assigned to the various channels and the information elements are not limited names in any point of view.

In the present disclosure, the terms “base station (BS)”, “radio base station”, “base station device”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to by a term such as a “macrocell”, a “small cell”, a “femtocell”, and a “picocell”.

The base station can accommodate one or more (for example, three) cells. In a case in which the base station accommodates multiple cells, the entire coverage area of the base station can be partitioned into a plurality of small areas, and each small area can provide a communication service through a base station subsystem (for example, a small indoor base station (RRH: Remote Radio Head) ). The term “cell” or “sector” refers to the whole or a part of the coverage area of at least one of the base station and the base station subsystem that performs a communication service in the coverage.

In the present disclosure, when a base station transmits information to a terminal, this may be interpreted as meaning that the base station controls or sends a command to the terminal based on the information.

In the present disclosure, the terms “mobile station (MS)”, “user terminal”, “user equipment (UE)”, “terminal”, and the like can be used interchangeably.

The mobile station may be referred to, by a person ordinarily skilled in the art, as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other suitable terms.

At least one of the base station and the mobile station may be also referred to as a “transmission device”, a “receiving device”, a “communication device”, or the like. At least one of the base station and the mobile station may be a device installed in a mobile body, a mobile body itself, or the like. The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IOT) device such as a sensor.

Furthermore, the base station in the present disclosure may be replaced by the user terminal. For example, various embodiments and examples of the present disclosure may be applied to a configuration in which communication between the base station and the user terminal is replaced by communication between multiple terminals 20 (such communication may be referred to as “device-to-device (D2D) ” communication, “vehicle-to-everything (V2X)” communication, etc. ). In this case, the terminals 20 may have and perform the functions that the base station 10 described above has. The phrases “uplink” and “downlink” may also be replaced by phrases corresponding to terminal-to-terminal communication (for example, “side”). For example, an uplink channel, a downlink channel, or the like may be replaced by a side channel.

Similarly, the user terminal in the present disclosure may be replaced with the base station. In this case, the base station may have the functions of the above-described user terminal.

The terms “determination (determining)” and “decision (determining) ” used in the present specification may include various types of operations. The “determination” and “decision” may include deeming “judging”, “calculating”, “computing”, “processing”, “deriving”, “investigating”, “looking up (for example, searching in a table, a database, or another data structure)”, “searching”, “inquiring”, or “ascertaining” as “determining” and/or “deciding”. Furthermore, the “determination” and “decision” may include deeming “receiving (for example, receiving information)”, “transmitting (for example, transmitting information)”, “inputting”, “outputting”, or “accessing (for example, accessing data in a memory)” as “determining” and/or “deciding”. Furthermore, the “determination” and “decision” may include deeming “resolving”, “selecting”, “choosing”, “establishing”, or “comparing” as “determining” and/or “deciding”. Namely, the “determination” and “decision” may include deeming an operation as “determining” and/or “deciding”. Furthermore, “determining” may be replaced with “assuming”, “expecting”, “considering”, or the like.

The terms “connected”, “coupled”, or variations thereof may mean any direct or indirect connection or coupling between two or more elements and may include the presence of one or more intermediate elements between two elements which are “connected” or “coupled”. The coupling or the connection between the elements may be physical, logical, or a combination thereof. For example, “connection” may be replaced with “access”. In the present disclosure, two elements may be considered to be “connected” or “coupled” with each other using at least one of one or more electric wires, cables and/or a printed electrical connection or using electromagnetic energy having a wavelength in a radio frequency region, a microwave region, or a light (both visible and non-visible) region as non-limiting and non-exhaustive examples.

A reference signal may be abbreviated as “RS” and may be referred to as a “pilot”, depending on the standard that is applied.

The phrase “based on” used in the present disclosure does not only mean “based only on”, unless otherwise stated. £ In other words, the phrase “based on” means both “based only on” and “based at least on”.

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

Furthermore, “means” in the structure of each of the above devices may be replaced with “unit”, “part”, “circuit”, “device”, or the like.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may include one or more frames in the time domain. In the time domain, each of one or more frames may be referred to as a “subframe”. The subframe may further include one or more slots in the time domain. The subframe may have a fixed time length (for example, 1 ms) not depending on numerology.

Numerology may be a communication parameter applied to at least one of transmission and reception of a certain signal or channel. For example, numerology may indicate at least one of subcarrier spacing (SCS), the bandwidth, the symbol length, the cyclic prefix length, the transmission time interval (TTI), the number of symbols per TTI, the radio frame Structure, a specific filtering process performed in the frequency domain by a transceiver, a specific windowing process performed in the time domain by a transceiver, and the like.

A slot may include one or more symbols (orthogonal frequency division multiplexing (OFDM) symbols, single carrier frequency division multiple access (SC-FDMA) symbols, etc.) in the time domain. A slot may be a time unit based on numerology.

A slot may include a plurality of mini slots. Each mini slot may include one or more symbols in the time domain. Furthermore, a mini slot may be referred to as a “sub-slot”. A mini slot may include fewer symbols than slot. PDSCH (or PUSCH) that is transmitted in a unit of time greater than a mini slot may be referred to as “PDSCH (or PUSCH) mapping type A”. PDSCH (or PUSCH) that is transmitted using a mini slot may be referred to as “PDSCH (or PUSCH) mapping type B”.

Any one of a radio frame, a subframe, a slot, a mini slot, and a symbol indicates a time unit for transmitting a signal. As a radio frame, a subframe, a slot, a mini slot, and a symbol, different names corresponding to them may be used.

For example, one subframe may be referred to as a “transmission time interval (TTI)”, or a plurality of consecutive subframes may be referred to as a “TTI”, or one slot or one mini slot may be referred to as a “TTI”. In other words, at least one of the subframe and the TTI may be a subframe (1 ms) in conventional LTE, may be a period shorter than 1 ms (for example, 1 to 13 symbols), or may be a period longer than 1 ms. A unit representing the TTI may be referred to as a “slot”, a “mini slot”, or the like, instead of a “subframe”.

Here, for example, the TTI refers to a minimum time unit of scheduling in wireless communication. For example, in an LTE system, the base station performs scheduling of allocating radio resources (frequency bandwidth, transmission power, or the like which can be used in each terminal 20) to each terminal 20 in units of TTIS. The definition of the TTI is not limited thereto.

The TTI may be a transmission time unit such as a channel-coded data packet (transport block), a code block, or a codeword, or may be a processing unit of, for example, scheduling or link adaptation. Furthermore, when a TTI is provided, the time interval (for example, the number of symbols) in which a transport block, a code block, a codeword, or the like is actually mapped may be shorter than the TTI.

When one slot or one mini slot is referred to as a “TTI”, one or more TTIs (that is, one or more slots or one or more mini slots) may be a minimum time unit of scheduling. Furthermore, the number of slots (the number of mini slots) forming the minimum time unit of scheduling may be controlled.

A TTI having a time length of 1 ms may be referred to as a “common TTI” (TTI in LTE Rel. 8 to 12), a “normal TTI”, a “long TTI”, a “common subframe”, a “normal subframe”, a “long subframe”, a “slot”, or the like. A TTI shorter than a common TTI may be referred to as a “reduced TTI”, a “short TTI”, a “partial TTI” (a partial or fractional TTI), a “reduced subframe”, a “short subframe”, a “mini slot”, a “sub slot”, a “slot”, or the like.

Furthermore, a long TTI (for example, a normal TTI, a subframe, etc.) may be replaced with a TTI having a time length exceeding 1 ms, and a short TTI (for example, a reduced TTI or the like) may be replaced with a TTI having a TTI length that is shorter than a TTI length of a long TTI and that is longer than or equal to 1 ms.

The resource block (RB) is a resource allocation unit in the time domain and the frequency domain, and may include one or more consecutive subcarriers in the frequency domain. The number of subcarriers included in an RB may be the same, irrespective of the numerology and may be, for example, 12. The number of subcarriers included in an RB may be determined based on numerology.

An RB may include one or a plurality of symbols in the time domain, and may be one slot, one mini-slot, one subframe, or one TTI in length. One TTI, subframe, and so on each may be constituted of one or a plurality of resource blocks.

Furthermore, one or more RBs may be referred to as a “physical resource block (PRB)”, a “subcarrier group (SCG)”, a “resource element group (REG)”, a “PRB pair”, an “RB pair”, or the like.

Furthermore, a resource block may be formed with one or more resource elements (REs). For example, one RE may be a radio resource field of one subcarrier and one symbol.

A bandwidth part (BWP) (which may be referred to as a “partial bandwidth” or the like) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include BWP for UL (UL BWP) and BWP for DL (DL BWP). In the terminal 20, one or more BWPs may be configured in one carrier.

At least one of configured BWPs may be active, and UE need not assume that predetermined signals/channels are transmitted and received outside an active BWP. Furthermore, a “cell”, a “carrier”, or the like in the present disclosure may be replaced with a “BWP”.

Structures of the radio frame, the subframe, the slot, the mini slot, and the symbol are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the cyclic prefix (CP) length, and the like can be variously changed.

In the present disclosure, for example, when an article such as “a”, “an”, or “the” in English is added by a translation, the present disclosure may include a case in which a noun following the article is the plural.

In the present disclosure, “A and B are different” may mean “A and B are different from each other” However, this may also mean “A and B are different from C”. Terms such as “separated” or “combined” may be interpreted as well as “different”.

Each embodiment or example described in the present disclosure may be used alone, in combination, or may be switched in accordance with the implementation. Furthermore, notification of predetermined information (for example, notification of “being X”) is not limited to notification performed explicitly, but may be performed implicitly (for example, not notifying the predetermined information).

Although the present disclosure has been described above in detail, it is obvious to those skilled in the art that the present disclosure is not limited to the embodiment described in the present disclosure. The present disclosure may be implemented as revised and modified embodiments without departing from the gist and scope of the present disclosure as set forth in the accompanying claims. Accordingly, the description of the present disclosure is for the purpose of illustration and does not have any restrictive meaning to the present disclosure.

### DESCRIPTION OF THE REFERENCE NUMERALS

10 base station
10A source base station
10B target base station
10C MN
10D SN
10E first RAN node
10F second RAN node
10G CU
10H DU
110 transmitting unit
120 receiving unit
130 configuration unit
140 control unit
20 terminal
210 transmitting unit
220 receiving unit
230 configuration unit
240 control unit
30 core network
1001 processor
1002 storage device
1003 auxiliary storage device
1004 communication device
1005 input device
1006 output device
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 rotation speed sensor
2023 air pressure sensor
2024 vehicle speed sensor
2025 acceleration sensor
2026 brake pedal sensor
2027 shift lever sensor
2028 object detection sensor
2029 accelerator pedal sensor
2030 driver assistance system unit
2031 microprocessor
2032 memory (ROM, RAM)
2033 communication port (IO port)

1. A terminal comprising:
a control unit configured to determine whether or not to employ short control signaling (SCS) transmission in an unlicensed band;
a transmitting unit configured to carry out transmission without performing listen before talk (LBT) when the control unit determines to employ SCS transmission; and
a receiving unit configured to perform LBT when the control unit determines not to employ SCS transmission,
wherein the transmitting unit is configured to carry out transmission, when the control unit determines not to employ SCS transmission and the receiving unit ends LBT successfully.

2. The terminal according to claim 1, wherein the control unit is configured to determine whether or not the terminal is located in a specific geographic region, and to determine to employ SCS transmission when the terminal is located in the specific geographic region.

3. The terminal according to claim 1, wherein the control unit is configured to determine whether or not the terminal is located in a specific geographic region based on a mobile country code (MCC) included in system information.

4. The terminal according to claim 1,
wherein the receiving unit is configured to receive downlink control information from a base station, and
wherein the control unit is configured to determine whether or not to employ SCS transmission based on the downlink control information.

5. The terminal according to claim 1, wherein the transmitting unit is configured to perform random access channel transmission without performing LBT, when the control unit determines to employ SCS transmission.

6. A communication method to be executed by a terminal, comprising:
a step of determining whether or not to employ short control signaling (SCS) transmission in an unlicensed band;
a step of carrying out transmission without performing listen before talk (LBT) upon determining to employ SCS transmission;
a step of performing LBT upon determining not to employ SCS transmission; and
a step of carrying out transmission, upon determining not to employ SCS transmission and successfully ending LBT.
